(19) United States
(12) Patent Application Publication
(10) Pub. No.: US 2017/0227087 A1
(43) Pub. Date: Aug. 10, 2017

(54) Assembly Concept For A Torsional Vibration Damping Arrangement For The Powertrain Of A Vehicle

(71) Applicant: ZF FRIEDRICHSHAFEN AG, Friedrichshafen (DE)

(72) Inventors: Thomas DÖGEL, Nüdlingen (DE); Ingrid HOFFELNER, Knetzgau (DE); Paul ESCH, Theres (DE); Cora CARLSON, Dittelbrunn (DE); Tobias DIECKHOFF, Würzburg (DE)

(73) Assignee: ZF FRIEDRICHSHAFEN AG, Friedrichshafen (DE)

(21) Appl. No.: 15/503,368

(22) PCT Filed: Jul. 6, 2015
(86) PCT No.: PCT/EP2015/065286

§ 371 Date: Feb. 10, 2017

(30) Foreign Application Priority Data
Nov. 8, 2014 (DE) 10 2014 215 859.1

(51) Int. Cl. F16F 15/134; F16F 15/131

(52) U.S. Cl. CPC F16F 15/13469; F16F 15/13157; F16H 45/02

(57) ABSTRACT

A torsional vibration damping arrangement, having an input region and an output region. There is provided between the input and output region a first torque transmission path and, a parallel second torque transmission path and a coupling arrangement for superposing the torques. A phase shifter arrangement in the first torque transmission path generates a phase shift of rotational irregularities. The phase shifter arrangement is a preassembled unit having at least a first connection point and second connection points, and the coupling arrangement is a preassembled unit having a first connection point corresponding to the phase shifter first connection point assembly unit and a second connection point corresponding to the phase shifter arrangement second connection point. The connection points of the phase shifter assembly unit are axially joined to the connection points of the coupling arrangement assembly unit during an assembly of the phase shifter assembly.

### CROSS REFERENCE TO RELATED APPLICATION

This is a U.S. national stage of application No. PCT/EP2015/065286, filed on Jul. 6, 2015. Priority is claimed on German Application No. DE102014215859.1, filed Aug. 11, 2014, the content of which is incorporated here by reference.

### BACKGROUND OF THE INVENTION

1. Field of the Invention

The present invention is directed to an assembly concept for a torsional vibration damping arrangement for the powertrain of a vehicle, comprising an input region to be driven in rotation around an axis of rotation and an output region, there being provided between the input region and the output region a first torque transmission path and, parallel thereto, a second torque transmission path and a coupling arrangement for superimposing the torques directed via the torque transmission paths, wherein a phase shifter arrangement is provided in the first torque transmission path for generating a phase shift of rotational irregularities conducted via the first torque transmission path relative to rotational irregularities conducted via the second torque transmission path.

2. Description of Prior Art

A generic torsional vibration damping arrangement known from German patent application DE 10 2011 007 118 A1 divides the torque introduced into an input region, for example, through a crankshaft of a drive unit, into a torque component transmitted via a first torque transmission path and a torque component directed via a second torque transmission path. Not only is there a static torque divided with this torque division, but also the vibrations and rotational irregularities generated, for example, by the periodically occurring ignitions in a drive unit and contained in the torque to be transmitted are also divided proportionately into the two torque transmission paths. The torque components transmitted via the two torque transmission paths are brought together again in a coupling arrangement constructed as planetary gear unit with a planet wheel, an input element and an output element and are then introduced as total torque into the output region, for example, a friction clutch or the like.

A phase shifter arrangement constructed in the manner of a vibration damper, i.e., with a primary side and a secondary side that is twistable with respect to the primary side through the compressibility of a spring arrangement, is provided in at least one of the torque transmission paths. In particular when this vibration system passes into a supercritical state, i.e., when it is excited by vibrations, more precisely, in this instance, torsional vibrations, exceeding the resonant frequency of the vibration system, a phase shift of up to 180° occurs. This means that at maximum phase displacement the vibration components proceeding from the vibration system are shifted in phase by 180° with respect to the vibration components received by the vibration system. Since the vibration components conducted via the other torque transmission path do not undergo a phase shift or, if so, a different phase shift, the vibration components which are contained in the unified torque components and which are then shifted in phase with respect to one another are destructively superimposed on one another such that, ideally, the output torque introduced into the output region is a static torque which contains essentially no vibration components.

### SUMMARY OF THE INVENTION

Proceeding from the background art cited above, it is an object of one aspect of the present invention to develop an assembly concept for a torsional vibration damping arrangement such that the torsional vibration damping arrangement is preferably produced within the framework of an industrialized assembly process in an economical, time-saving, reproducible, and process-reliable manner.

According to one aspect of the invention, this object is met through an assembly concept for a torsional vibration damping arrangement for the powertrain of a motor vehicle comprising an input region to be driven in rotation around a rotational axis (A) and an output region, the input region comprising a primary mass and the output region comprising a secondary mass, and a coupling arrangement that communicates with the output region. The coupling arrangement comprises a first input element, a second input element and an output element. A torque transmission path for transmitting a total torque extends between the input region and the output region. The torque transmission path from the input region to the coupling arrangement is divided into a first torque transmission path for transmitting a first torque component and a parallel, second torque transmission path for transmitting a second torque component. The first torque transmission path, the second torque transmission path and, therefore, the first torque component and the second torque component are guided together again at the coupling arrangement to form an output torque, and a phase shifter arrangement in the first torque transmission path comprising a vibration system with a first stiffness, wherein the first stiffness comprises a spring arrangement, and wherein an input torsional vibration proceeding from the input region is divided into a first torsional vibration component and a second torsional vibration component by being conducted via the first torque transmission path and via the second torque transmission path. During an operation of the vibration system in a speed range above at leas one limit speed at which the vibration system is operated in a resonant range, the first torsional vibration component and the second torsional vibration component are superimposed at the coupling arrangement such that the first torsional vibration component and the second torsional vibration component are destructively superimposed, and an output torsional vibration, which is minimized relative to the input torsional vibration, is accordingly present at the output element of the coupling arrangement. The phase shifter arrangement is constructed as a preassembled phase shifter assembly unit comprising at least a first connection point and a second connection point, and the coupling arrangement is constructed as a preassembled coupling arrangement assembly unit comprising at least a first connection point corresponding to the first connection point of the phase shifter assembly unit and a second connection point corresponding to the second connection point of the phase shifter arrangement. The connection points of the phase shifter assembly unit are axially joined to the connection points of the coupling arrangement assembly unit during an assembly of the phase shifter assembly unit with the coupling arrangement assembly unit.

Splitting the assembly of the torsional vibration damping arrangement into two assembly units, in this case the phase shifter assembly unit and the coupling arrangement assembly unit, is particularly advantageous in terms of assembly because they can be preassembled separately from one another. The above-mentioned connection points are necessary for this purpose in that they allow the two assembly units 83, 51 to be separated from one another or brought together in axial direction. In a particularly advantageous embodiment form, the coupling arrangement assembly unit includes the coupling arrangement and a radially outer torsion damper. The phase shifter assembly unit comprises a control element for the torsion damper of the coupling arrangement assembly unit, which control element can be guided into this torsion damper in axial direction, and possibly a further, radially inner torsion damper. Separating the assembly units at this location affords the great advantage that the axial engagement of the control element between the springs of the torsion damper results in a connection point, which engages positively in circumferential direction and which can be connected and disconnected in axial direction without the use of tools. Further, during axial engagement the segments of the control element that extend between the springs of the outer spring set engage with one another already before the two assembly units come in contact with the other connection point in the region of the input sunwheel. In the embodiment example, this means that the assembly units are already aligned with one another before the engine-side cover plate of the inner torsion damper rests on a cylindrical surface of the input sunwheel. Since, as a result, the parts can no longer twist freely opposite one another when they are in contact, this contacting or fit can be configured as an interference fit to secure the parts in their position. Accordingly, it is advantageous to bond the two parts to one another by a welding process, advantageously a laser welding process.

In an advantageous configuration, the coupling arrangement comprises a planetary gear unit with a planet wheel carrier, a planet wheel pin fastened to the planet wheel carrier, and a planet wheel element rotatably supported at the planet wheel pin. The planet wheel element is connected to the input region by the first input element and by the second input element. The planet wheel element is connected to the output region by the output element.

In so doing, the first torque component and the first torsional vibration component are directed to the planet wheel element of the coupling arrangement via the first torque transmission path by the first input element, whereas the second input element guides the second torque component and the second torsional vibration component rigidly to the planet wheel element by the second torque transmission path. The first torque component and the second torque component and the first torsional vibration component and the second torsional vibration component are guided together again or, more precisely, superimposed at the planet wheel element and conveyed to the output element as output torque and as output torsional vibration. In an advantageous embodiment, for example, the output element can receive a friction clutch. The first input element is connected in its operative direction on the one side to the phase shifter arrangement and on the other side to the planet wheel element. The second input part is connected in its operative direction on the one side to the input region and on the other side to the planet wheel element. The superposition unit in turn is connected in its operative direction on the one side to both the first input part and the second input part and on the other side to the output part. The output part forms the output region and can receive a friction clutch in an advantageous embodiment.

In order to achieve the phase shift in a simple manner in one of the torque transmission paths, it is suggested that the phase shifter arrangement comprises a vibration system with a primary mass and an intermediate element which is rotatable with respect to the primary mass around the axis of rotation A against the action of a spring arrangement. A vibration system of this type can be constructed as a kind of vibration damper, known per se, in which the resonant frequency of the vibration system can be adjusted in a defined manner, particularly by influencing the primary-side mass and secondary-side mass as well as the stiffness of the spring arrangement, and the frequency at which there is a transition to the supercritical state can accordingly also be determined.

In a further advantageous embodiment, the first connection point and second connection point of the phase shifter assembly unit and the corresponding first connection point and second connection point of the coupling arrangement assembly unit are displaceable relative to one another in an axial direction along the axis of rotation (A), and at least one of the connection points of the phase shifter assembly unit and at least one of the corresponding connection points of the coupling arrangement assembly unit are constructed so as to engage positively with respect to one another in a circumferential direction around the axis of rotation (A). As has already been mentioned, this can advantageously be the connection point located radially outward and through which the control element of the phase shifter assembly unit engages in the spring arrangement of the coupling arrangement assembly unit. At this connection point, the structural component parts are axially displaceable relative to one another, but there is a positive-engagement connection in circumferential direction around the axis of rotation A.

A further advantageous embodiment provides that the coupling arrangement assembly unit comprises a spring set arranged in series with the spring set of the phase shifter assembly unit after assembly of the coupling arrangement assembly unit with the phase shifter assembly unit. A larger spring deflection can be achieved by this embodiment, which can have an advantageous result for the decoupling quality. This division of the two spring sets is also advantageous for assembly because one spring set is mounted per assembly unit.

A further advantageous configuration provides that when joined axially at least one of the connection points of the phase shifter assembly unit and one of the corresponding connection points of the coupling arrangement assembly unit form an interference fit. To this end, it is advantageous when at least one of the connection points is so constituted in the tolerance chain that before being joined axially the adjoining parts to be connected to one another have a degree of freedom in the direction of rotation around the axis of rotation of the assembly unit. In this way, it is achieved that the two parts can be aligned with one another corresponding to the output position of the torsion damper and of the coupling gear unit, and all of the tolerances of the assembly unit in circumferential direction viewed around the axis of rotation A are compensated. In the present solution, this is realized in that the engine-side cover plate of the radially inner spring arrangement has a bore hole which rests on a cylindrical outer surface of the input sunwheel, and the parts can accordingly be guided together at any twist angle. The joining method itself must also be suitable for connecting the two parts in any position relative to one another with respect to a rotation around the axis of rotation of the assembly unit. A bonding connection by (laser) welding is particularly suitable for this purpose as has already been described.

A further advantageous embodiment provides that after the axial joining of the phase shifter assembly unit with the coupling arrangement assembly unit at least one of the connection points of the phase shifter assembly unit is connected to the corresponding connection point of the coupling arrangement assembly unit by a bonding connection method. As has already been described, it is particularly advantageous that after the axial joining the cover plate, as first connection point of the phase shifter assembly unit 83, with its radially inner bore hole is bonded to the cylindrical outer surface of the input sunwheel as corresponding first connection point of the coupling arrangement assembly unit.

In a further advantageous configuration with respect to the arrangement described above, the bonding connection method is a welding method. The laser welding method is mentioned in particular in this respect. However, other suitable welding methods can also be used.

A further advantageous embodiment provides that before the phase shifter assembly unit is assembled with the coupling arrangement assembly unit, the planet wheel element is secured against rotation with respect to the planet wheel carrier by a fixating element. This can be carried out through fixation by at least one fixating element, for example, a bolt or a pin, which is inserted during assembly through corresponding bore holes in at least one planet wheel element, the planet wheel carrier and, optionally, a part on the output side of the phase shifter arrangement, which part is connected to the input ring gear so as to be fixed with respect to rotation relative to it. However, other contours can also be used as bore holes for fixating, for example, a plurality of outer surfaces or a tooth gap of a planet wheel element. The fixation is preferably constructed such that an erroneous installed position is impossible (poka-yoke). The following cases and possible solutions to these cases must be distinguished. For one, it may be that the planet wheel elements are configured such that it is optional whichever front side of the planet wheel element faces the engine-side direction or transmission-side direction. The reference contour of the planet wheel element is accordingly to be arranged symmetrically with respect to the bisector of the segment angle of the planet wheel element for the fixation and is equally accessible from both sides of the planet wheels, for example, the through-hole or the tooth gap. The deflection of the planet wheel element in the output position is defined by the reference contours at the planet wheel carrier. In this way, it is always ensured that, regardless of which front side of the planet wheel faces in direction of the engine or in direction of the transmission, the correct swiveling angle is adjusted for pull operation and push operation. The freedom of choice of the installed position is preserved and facilitates the assembly. A solution of this kind is shown in FIGS. 7 and 8.

In case the planet wheel element also requires a suitably positioned installation with regard to which of its sides faces in direction of the engine or in direction of the transmission, such as could be necessary, for example, with an asymmetrical toothing correction, the following arrangement in advantageous. The reference contours at the planet wheels are only accessible from one side. This can be achieved, for example, through a blind bore hole. It is then also possible for the position of the reference contours to be asymmetrical with respect to the bisector of the segment angle. This solution is shown in FIGS. 3 and 4.

It is particularly advantageous when the fixating element additionally axially contacts the transmission-side surface and in the region of the segment of the planet wheel element that meshes with the input sunwheel. Accordingly, the radially inner segment of the planet wheel element can be tilted in direction of the input region within the framework of the bearing clearance of the planet wheel bearing, which facilitates the insertion of the input sunwheel. This can be implemented, for example, in that the corresponding bore hole in the planet wheel element has a smaller diameter than in the other structural component part. The corresponding pin or the fixating element then has two different diameters, and the step between the smaller, first diameter which penetrates into the planet wheel element and the larger, second diameter axially contacts the planet wheel on the transmission side. This arrangement is clearly shown in FIGS. 3, 4, 7 and 8.

A further advantageous configuration provides that the planet wheel element comprises a recess and the planet wheel carrier comprises a corresponding recess, and the fixating element is inserted into both recesses in order to prevent a rotation of the two component parts relative to one another. This embodiment has already been mentioned above.

In a further advantageous embodiment form, an engine-side cover plate of the phase shifter assembly unit is connected via a lockup clutch to a disk carrier so as to be fixed with respect to rotation relative to it. This embodiment form is particularly space-saving axially. Further, the cover plate and the disk carrier can be fashioned economically from one structural component part, for example, as a deep-drawn structural component part.

Further, a transmission-side cover plate can also be connected to a turbine of a torque converter so as to be fixed with respect to rotation relative to it. Here again, an axially compact embodiment form is prominent.

To further improve the assembly concept, the radially outwardly arranged connection point of the phase shifter assembly unit can advantageously comprise a hub disk, and the corresponding connection point of the coupling arrangement assembly unit can advantageously comprise a hub ring. In this regard, at least one spring control segment for controlling the radially outwardly arranged spring arrangement and a torsion stop segment are advantageously provided radially outwardly at the hub disk. The hub ring likewise comprises at least one corresponding spring control segment and a corresponding torsion stop segment. During a relative rotation of the hub disk with respect to the hub ring against a force of the radially outer spring arrangement, the relative rotation can be limited by the integrated torsion stop segments. The arrangement of the torsion stop segments radially outwardly is also to be considered as positive with respect to the introduced forces, since the lever arm has a positive effect on the loading of the torsion stop segments.

In a further advantageous configuration, the hub disk comprises a spring control segment and a torsion stop segment and the hub ring likewise comprises a spring control segment and a torsion stop. This embodiment has already been described.

Further, the radially outer spring arrangement can be clamped between the spring control segment of the hub disk and the spring control segment of the hub ring after the phase shifter assembly unit has been assembled with the coupling arrangement assembly unit.

### BRIEF DESCRIPTION OF THE DRAWINGS

Preferred embodiment examples of the invention will be described in the following with reference to the accompanying drawings. The drawings:

FIG. 1 is a schematic diagram showing possible assembly positions and assembly units of a torsional vibration damping arrangement;

FIG. 2 is a schematic diagram showing further possible assembly units of a torsional vibration damping arrangement;

FIG. 3 is a torsional vibration damping arrangement with a planet wheel element with an asymmetrical recess for fixating;

FIG. 4 is a cross section of the torsional vibration damping arrangement as described in FIG. 3;

FIG. 5 is an axial bearing support of the secondary mass of a torsional vibration damping arrangement;

FIG. 6 is a further axial bearing support of a secondary mass of a torsional vibration damping arrangement;

FIG. 7 is a torsional vibration damping arrangement with a planet wheel element with a symmetrical recess for fixating;

FIG. 8 is a cross section of the torsional vibration damping arrangement as described in FIG. 7;

FIG. 9 is a hub ring and a hub disk of a torsional vibration damping arrangement;

FIG. 10 is a phase shifter assembly unit and a coupling arrangement assembly unit of a torsional vibration damping arrangement;

FIG. 11 is a torsional vibration damping arrangement as combined construction with a lockup clutch and a torque converter;

FIG. 12 is a torsional vibration damping arrangement with an input ring gear and an output ring gear;

FIG. 13 is a torsional vibration damping arrangement as in FIG. 12 with disconnection points for assembly;

FIG. 14 is a torsional vibration damping arrangement as in FIG. 13, but with additional stiffness;

FIG. 15 is a torsional vibration damping arrangement as in FIG. 13 with arrangement for fixating a planet wheel element.

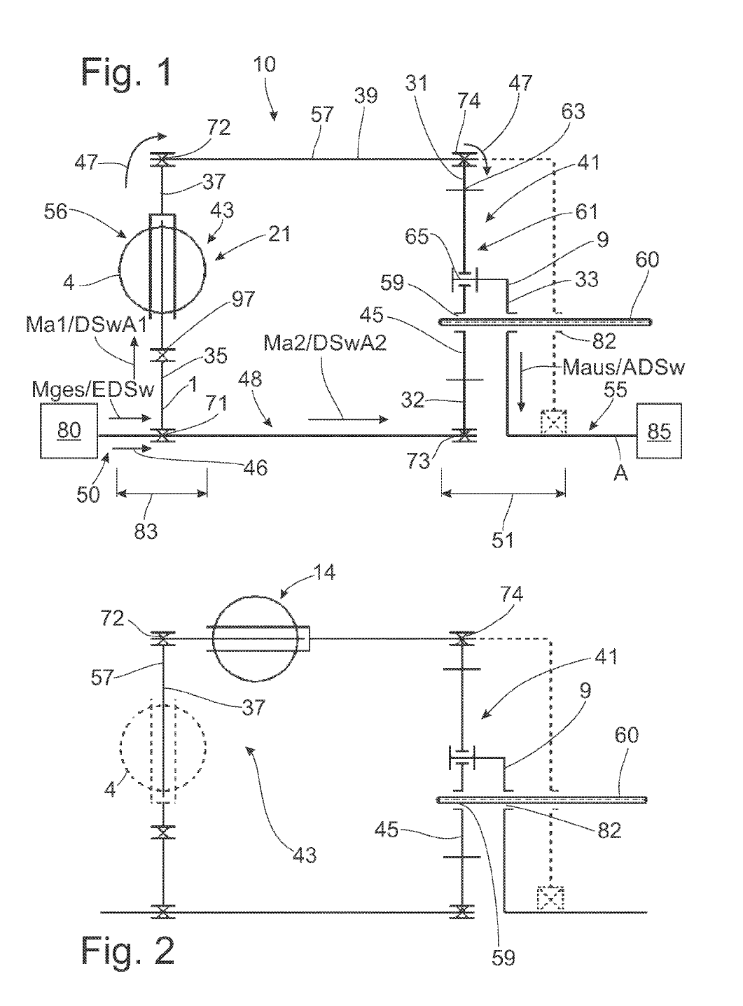

FIG. 1 is a schematic diagram of a torsional vibration damping arrangement 10 which comprises a phase shifter arrangement 43 and a coupling arrangement 41 that operates on the principle of power splitting or torque splitting. Advantageous connection points are, a first connection point 71 and a second connection point 72 of the phase shifter arrangement 43 and a first connection point 73 and a second connection point 74 of the coupling arrangement 41, which divide the phase shifter arrangement 43 into a phase shifter assembly unit 83 and divide the coupling arrangement 41 into a coupling arrangement assembly unit 51 to enable an advantageous assembly of these two prefabricated assembly units 83, 51. Further, an additional connection point 97 is provided in the area of the phase shifter assembly unit 83, although this can be considered as an optional connection point. The torsional vibration damping arrangement 10 can be arranged in a powertrain of a vehicle, for example, between a drive unit 80 forming an input region 50 in this instance and the subsequent portion of the powertrain, i.e., for example, a transmission unit 85 forming an output region 55 in this instance. The torsional vibration damping arrangement 10 comprises an input region designated generally by 50. This input region 50 can be connected, for example, to a crankshaft of an internal combustion engine, neither of which is shown, so as to be fixed with respect to rotation relative to it. The torque path runs from the input region 50 to the output region 55 in the following manner: A torque from the input region 50, which may also be referred to as total torque Mges is introduced into the torsional vibration damping arrangement 10, and is split into a first torque component Ma1 and a second torque component Ma2. The first torque component Ma1 is guided via a first torque transmission path 47 and the second torque component Ma 2 is guided via a second torque transmission path 48. Accordingly, an input torsional vibration EDSw, which proceeds especially from the drive unit 80, for example, a reciprocating piston engine, not shown, is split into a first torsional vibration component DSwA1, which is guided via the first torque transmission path 47 and a second torsional vibration component DSwA2 which runs via the second torque transmission path 48. The first torque transmission path 47 includes a phase shifter arrangement 43, which in the present instance, comprises a stiffness 21. The stiffness is preferably formed from at least one helical spring.

The torque path of the first torque component Ma1 and accordingly also the path of the first torsional vibration component DSwA1 in the first torque transmission path 47 runs from the input region 50 via an input element 35 to stiffness 21. The first torque component Ma1 with the first torsional vibration component DSwA1 is guided from stiffness 21 by an output element 37 to a first input element 31 of coupling arrangement 41. The first input part 31 of the coupling arrangement 41 is connected to the output element 37 of the stiffness 21 so as to be fixed with respect to rotation relative to it. The first input part 31 of the coupling arrangement 41 is constructed in this instance as an input ring gear 63.

In the second torque transmission path 48, the second torque component Ma2 with the second torsional vibration component DSwA2 is guided from the input region 50 directly to the planet wheel carrier 9 of the coupling arrangement 41 by an input sunwheel which, in this instance, forms the second input part 32 of the coupling arrangement. Consequently, the first torque component Ma1 and the second torque component Ma2 and the first torsional vibration component DSwA1, which is now shifted in phase, and the second torsional vibration component DSwA2 are guided together again at the coupling arrangement 41 to form a total output torque Maus and an output torsional vibration ADSw or, more precisely, torsional vibration components 1 and 2 are destructively superposed at the coupling arrangement. The aim of the destructive superposition is to minimize, optimally even to completely eliminate, the output torsional vibration ADSw compared to the input torsional vibrations EDSw so that there is no longer any torsional vibration at the output region 55.

In order to ensure a quick, economical assembly of the torsional vibration damping arrangement 10, it is advantageous as was already mentioned that two assembly units of the torsional vibration damping arrangement are preassembled. These two assembly units are the phase shifter assembly unit 83 and the coupling arrangement assembly unit 51 mentioned above. In this case, small subassemblies, for example, the spring arrangement 4, and other subassemblies can again be preassembled. By connection point 71, located in this instance radially inwardly at the phase shifter assembly unit 83, and connection point 72, located radially outwardly at phase shifter assembly unit 83, this assembly unit can be connected to the connection points 73 corresponding to connection point 71 and to connection point 74 of the coupling arrangement assembly unit 51 so as to be fixed with respect to relative rotation and axially displaceable. Joining in axial direction along the axis of rotation A is especially advantageous because the connection points can be configured in such a way that they are axially displaceable along the axis of rotation A but present a rotationally locked connection around the axis of rotation A. Accordingly, tolerances in assembly can be compensated in an advantageous manner. Additional connection point 97 can be used optionally and presents a further advantageous connection point.

FIG. 1 further shows an advantageous fixation of the planet wheel element 45 with respect to the planet wheel carrier 9 that forms the output element 33 of the coupling arrangement in this instance. In the embodiment shown here, a recess 59 in the form of a bore hole is arranged at the planet wheel element 45. The planet wheel carrier 9 comprises a corresponding recess 82 likewise in the form of a bore hole. When recess 59 and recess 82 are located one above the other, a fixating element 60, in the form of a bolt in this instance, can be inserted into the two recesses 59 and 82. Therefore, a relative rotation between planet wheel carrier 9 and planet wheel element 45 is no longer possible. Fixation can be particularly advantageous during assembly because a relative reference position of planet wheel element 45 with respect to the planet wheel carrier can make it possible to implement a more useful, and possibly also different, swiveling angle both in pull direction and push direction. Further, a blocked coupling arrangement 41 can be assembled more easily because there are fewer degrees of freedom of the coupling arrangement 41. The fixating element can also be inserted through a bore hole in the planet wheel carrier 9 and into a tooth gap of the planet wheel element 45, although this is not shown herein. In this case, recess 59 can be dispensed with.

FIG. 2 shows a schematic diagram of a further possible assembly unit of a torsional vibration damping arrangement. In this embodiment form, an additional spring arrangement 14 is arranged between the second connection point 72 of the phase shifter arrangement 43 and the second connection point 74 of the coupling arrangement 41. Accordingly, there results at this location a connection that is particularly advantageous because it forms a positive engagement in circumferential direction around the axis of rotation A but can be disconnected in axial direction along the axis of rotation A and can be used as disconnection point or connection point between two assembly units. For example, if the phase shifter arrangement 43 contains further spring arrangements, not shown herein, the output element of spring arrangement 4 can serve as intermediate element 57 between two spring arrangements arranged in series. The schematic diagram shows that it is then possible to divide into subassemblies also within the torsion damper when the output element 37 is divided into two individual elements at a disconnection point or connection point.

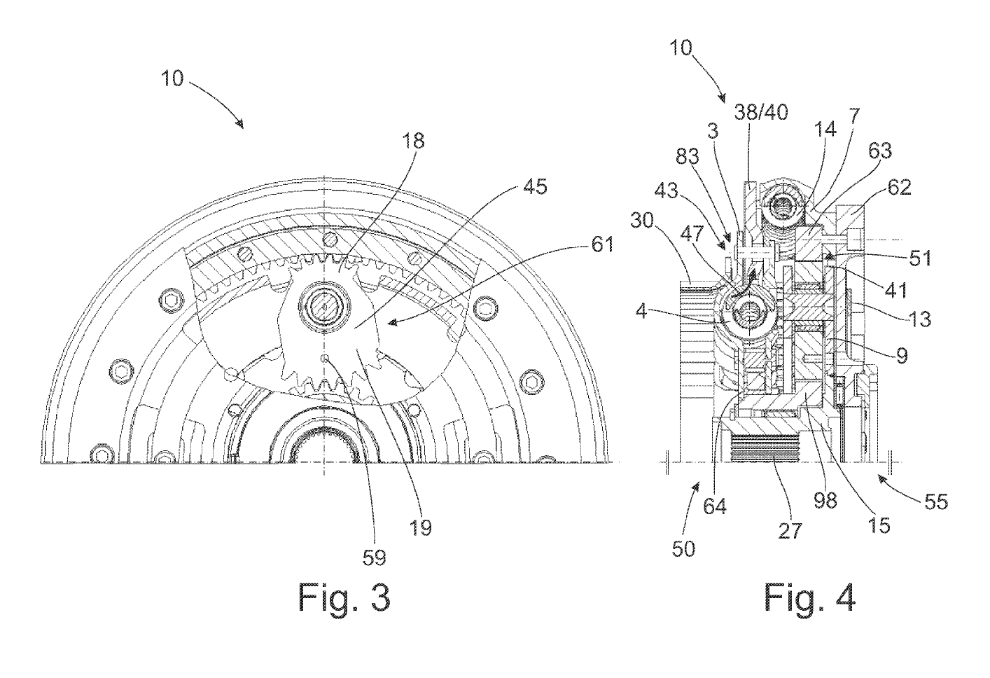

FIGS. 3 and 4 show a torsional vibration damping arrangement 10 such as can be used, for example, with a hydrodynamic torque converter, not shown. However, it is also possible to connect to another starting element of a powertrain in similar form. The assembly unit especially comprises a phase shifter assembly unit 83 and a coupling arrangement assembly unit 51. The input region 50 is formed by a disk carrier 30, which can be connected via a disk clutch, not shown, to an internal combustion engine, not shown. The engine-side cover plate 3 of the inner spring arrangement 4 is connected to the disk carrier 30 so as to be fixed with respect to rotation relative to it. The latter guide the torque from the drive unit into the spring arrangement 4 and accordingly form the first torque transmission path 47 of the torsional vibration damping arrangement 10. On the output side of the spring arrangement 4 is a hub disk 38 that serves as a control element 40 for a radially outer spring arrangement 14. The radially inner spring arrangement 4 and the radially outer spring arrangement 14 are arranged in series. Hub disk 38 is rotatably supported by a sliding bearing 64 radially relative to the input sunwheel 98 and axially relative to the engine side. The output of torque from the outer spring arrangement 14 takes place directly at the transmission-side cover plate 7. The transmission-side cover plate 7 is connected to the input ring gear 63 and an input ring gear carrier 62 so as t, be fixed with respect to relative rotation and, together with the latter, forms a secondary inertia of the phase shifter 43. The first, phase-shifted torque component Ma1 is introduced into the coupling gear unit 41 via the input ring gear 63. The second torque transmission path proceeds from the engine-side cover plate 3 of the inner spring set. This cover plate 3 is connected to the input sunwheel 98 so as to be fixed with respect to rotation relative to it, which input sunwheel 98 introduces the second torque component Ma2 into the coupling gear unit 41. The planet wheel element 45 has a first toothing area 18 that meshes with the input ring gear 63 and a second toothing area 19 that meshes with the input sunwheel 98. The pitch circle radii of the two toothing areas 18, 19 differ in this instance so as to achieve the necessary gear multiplication in the existing installation space. The planetary gear unit 61 can accordingly carry out swiveling movements only within a limited range. In order to economize on material, machining effort and installation space, the toothing areas 18, 19 are also constructed to be only as large as required by the swiveling range of the planetary gear unit 61 to be realized for operation. The swiveling range is given by a spring travel of the phase shifter arrangement 43 that determines the maximum rotation between the two input elements of the coupling gear unit 41, and the transmission ratio of the coupling gear unit 41 which is determined in an application-specific manner in order to achieve an optimal extinguishing of the input torsional vibration EDSw via the two input gears. A further reduction of the required swiveling area and, therefore, of the toothing areas 18, 19 results from the fact that less torque and, therefore, a smaller rotation angle occurs in the push direction of the internal combustion engine than in the pull direction. In an initial position, i.e., with relaxed spring arrangement 4, 14, the planet wheel element 45 is arranged asymmetrically with respect to a theoretical plane defined by its rotational axis and the rotational axis of the assembly unit, specifically such that there is more swiveling angle in the pull direction than in the push direction. A further limiting of the twist angle in pull direction and push direction results from an axial overlapping between the planet wheel carrier 9 and the input ring gear carrier 62. In the present construction, this overlapping results from the connection of a supporting ring 13, which is located on the transmission side of the input ring gear carrier 62, to the planet wheel carrier 9. The input ring gear carrier 62 and the portions of the output side of the phase shifter arrangement 43, which are connected to the input ring gear carrier 62, are accordingly also supported axially relative to the planet wheel carrier 9 in direction of the transmission, not shown. This additional bearing support serves, for one, to form a subassembly comprising portions of the coupling arrangement 41 and of the outer spring arrangement. Without the bearing support, the input ring gear 63 and the parts connected to it could be withdrawn axially from the rest of the coupling arrangement 41 in direction of the transmission, not shown, which would make handling more difficult over the course of further assembly. For another, the bearing support serves as an additional support and to secure against unwanted movements of heavy parts on the output side of the spring arrangement 14 during operation, which could be possible in a torque converter, for example, through an increase in the axial play of the bearings in the radially inner area as a result of distention.

The output region 55 is connected by a spline 27 of an output flange 15 that is connected to the planet wheel carrier 9 so as to be fixed with respect to rotation relative to it. In the vehicle, this spline 27 engages (not shown) with the transmission input shaft.

The object in terms of construction consists in ensuring that in the untwisted initial position of the spring arrangements 4, 14 all of the teeth are located relative to one another in such that they can be assembled ensuring the initial positions of the planet wheel element 45 and the planet wheel carrier 9 proceeding from which the swiveling ranges which are limited to the necessary degree are available in the pull direction and in the push direction. Owing to the length of the tolerance chain between the participating parts which must be taken into account and the required precision for assembly, it would be very uneconomical in technical respects relating to manufacture as well as with respect to costs to implement this requirement via correspondingly tight tolerances of the structural component parts.

As has already been shown in principle, the suggested approach consists specifically in that the connection between the engine-side cover plate 3 of the inner spring arrangement 4 and the input sunwheel 98 is not carried out until the assembly units have been assembled. This connection is to be carried out such that the two parts can be aligned with one another in any angular position with respect to their axis of rotation. Accordingly, all relevant tolerances of the assembly unit in circumferential direction are compensated at this location.

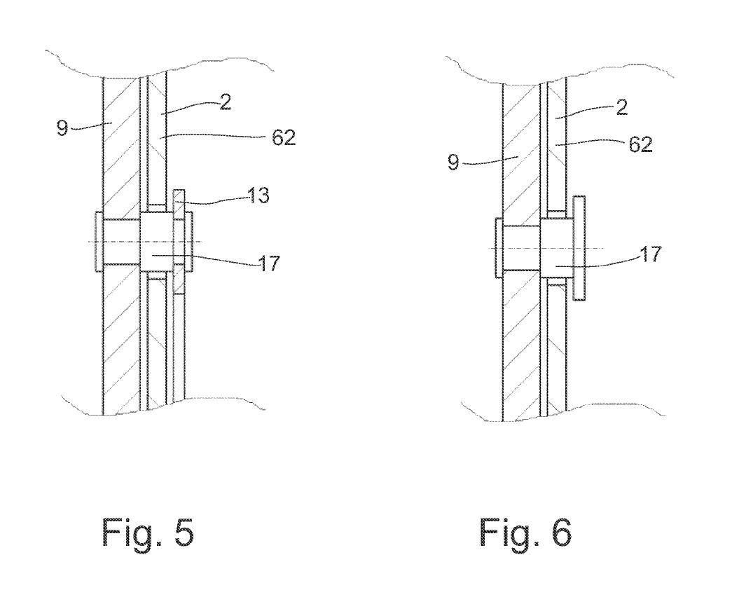

FIGS. 5 and 6 show an axial bearing support on both sides of the secondary mass 2 which in this instance and in the Figures described above preferably forms the input ring gear carrier 62. In FIG. 5, the supporting ring 13 is connected to the planet wheel carrier 9 by a spacer rivet 17 penetrating the input ring gear carrier 62 through a corresponding opening. In FIG. 6, the axial bearing support is carried out through the head of the spacer rivet 17 itself.

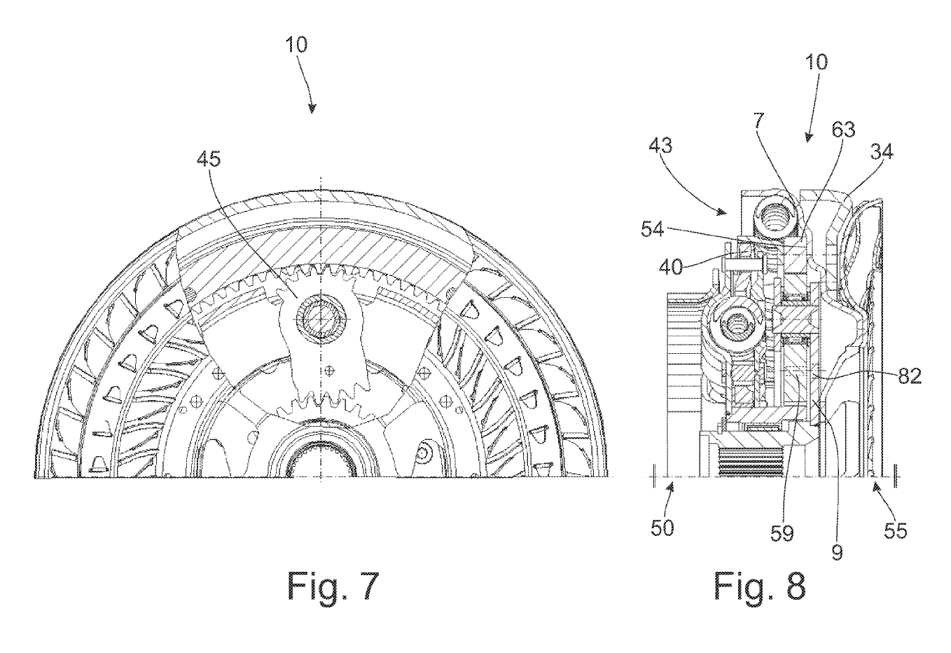

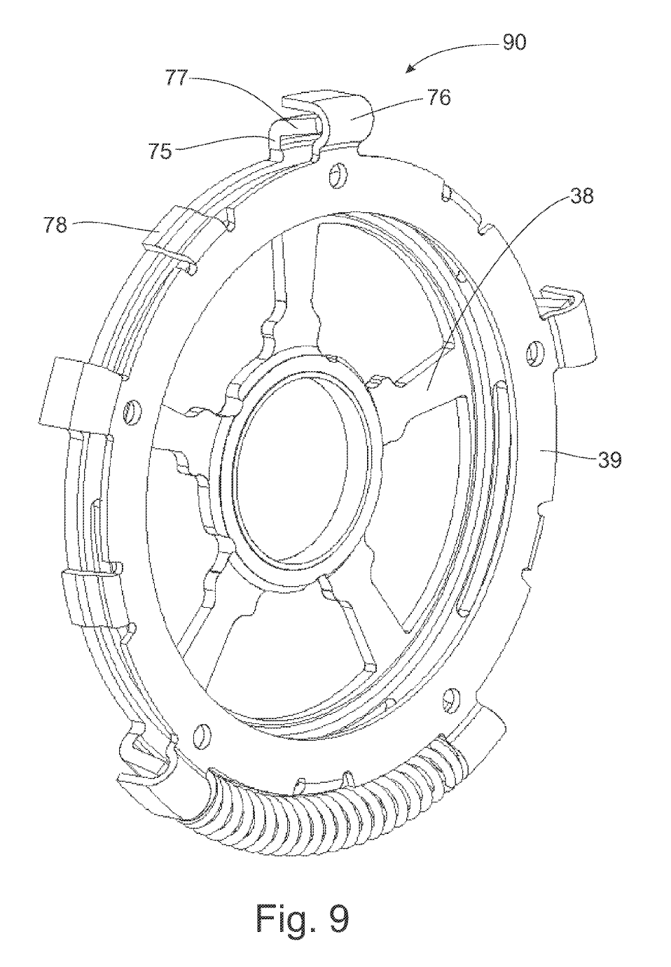

FIGS. 7, 8 and 9 show a torsional vibration damping arrangement 10 with a planet wheel element 45 having a symmetrical recess for fixation. For this purpose, a hub ring/hub disk arrangement 90 is used for the spring control of the radially outer spring arrangement 14. This arrangement comprises a hub ring 39 and a hub disk 38 as is shown in FIG. 9. Diverging from the construction shown in FIGS. 6 and 7, the transmission-side cover plate 7 of the outer spring arrangement 14 is formed such that it takes over the function of the input ring gear carrier 62 and axially supports all of the structural component parts connected to the output side of the spring arrangement 14 via a bearing in the radially inner area relative to the surrounding parts. The axial bearing support in direction of the input region 50 relative to the planet wheel carrier 9 is carried out as a sliding bearing. In the direction of output region 55, a sliding bearing or rolling element bearing support can be carried out relative to a converter housing or a stator assembly unit, neither of which is shown.

The use of the hub ring/hub disk arrangement 90 makes it possible to construct a phase shifter arrangement 43 which, as has already been described, contains a control element 40 that extends between the spring arrangements 4 and 14 from axial direction. Accordingly, this is particularly well suited for the assembly process that the core of the present invention disclosure. A hub ring 39 is used in this instance for output-side control of the spring arrangement 14. In its radially outer region, this hub ring 39 has at least one spring control segment 76 that extends between the springs of spring arrangement 14 to serve as a stop for the latter in circumferential direction. In addition, a torsion stop relative to the hub disk 38, which also comprises a spring control segment 75 and a torsion stop segment 77, can be carried out with regard to construction by at least one torsion stop segment 78 of the hub ring 39. These segments extend axially into the installation space of the input-side control element 40 and are positioned in circumferential direction such that they encounter the segments of the input-side control element 40 according to correspondingly defined twist angles of the spring set 14 and accordingly limit the relative twisting. FIG. 9 shows the interaction of hub ring 39 and hub disk 38 in detail. Only one spring is installed to serve as example.

The hub ring 39 contacts a plane surface 54 of the input ring gear 63 axially on the engine side. A rivet connection in particular can serve as connection between the hub ring 39, the input ring gear 63 and the transmission-side cover plate 7, by which rivet connection all three components can be connected to one another in one work step. However, other common joining methods are also possible.

To improve the function of the phase shifter arrangement 43, a mass ring 34 is connected to the output side of the spring arrangement 14 so as to be fixed with respect to rotation relative to it. This mass ring 34 can be constructed, for example, as a bent sheet metal part as is shown. A connection to the other parts of the output side of the spring arrangement 14, in this case the input ring gear 63, the transmission-side cover plate 7 and the hub ring 39, can be carried out, for example, by riveting or by welding. If the connection between the mass ring 34 and the transmission-side cover plate 7 is carried out prior to—in order of assembly—the riveting of cover plate 7 to the input ring gear 63 and hub ring 39, it is necessary that the mass ring 34 has, as is shown, corresponding openings on the pitch circle of these rivets through which a rivet tool can engage.

Further, it can be seen clearly from FIG. 7 that the planet wheel element 45 comprises a recess 59 through which a fixating element, not shown, can be guided through a recess 82 in the planet wheel carrier 9 in order to fixate the planet wheel element 45 relative to the planet wheel carrier 9.

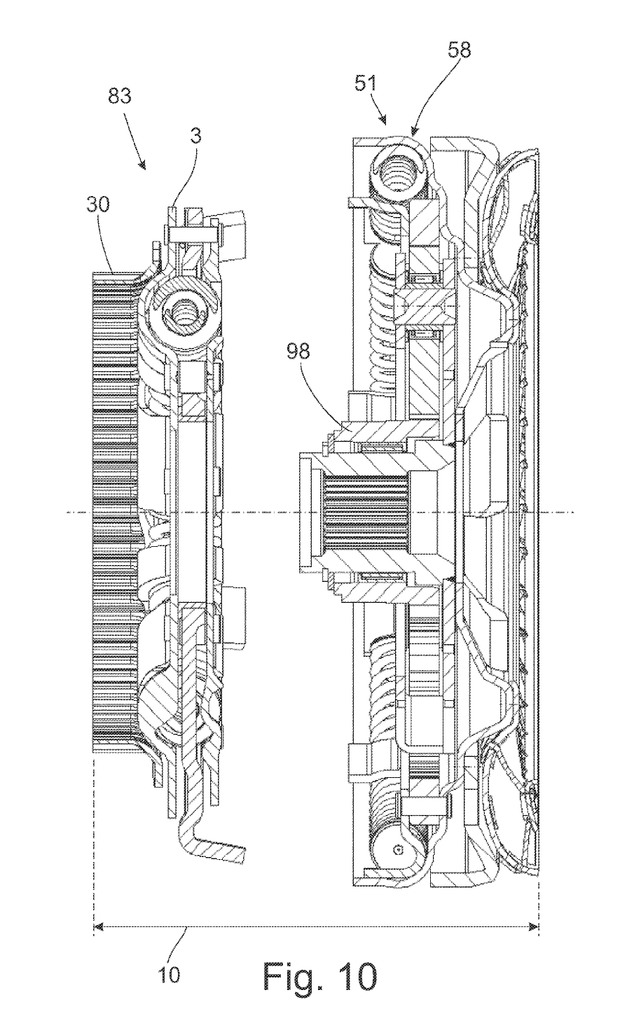

FIG. 10 shows a phase shifter assembly unit 83 and a coupling arrangement assembly unit 51 of a torsional vibration damping arrangement 10 prior to assembly. In order to illustrate the final assembly step, namely, the joining of the two subassemblies, in this case the phase shifter assembly unit 83 and the coupling arrangement assembly unit 51, the two subassemblies are shown in FIG. 10 separate from one another in the position proceeding from which they are subsequently inserted in axial direction one inside the other. Finally, the connection is advantageously secured, for example, by laser welding between the engine-side cover plate 3 and the input sunwheel 98. In an advantageous embodiment form, the connection of the engine-side cover plate 3 and the input sunwheel 98 can be configured as an interference fit. This is particularly advantageous because a twisting between the two structural component parts is difficult if not impossible after axial joining.

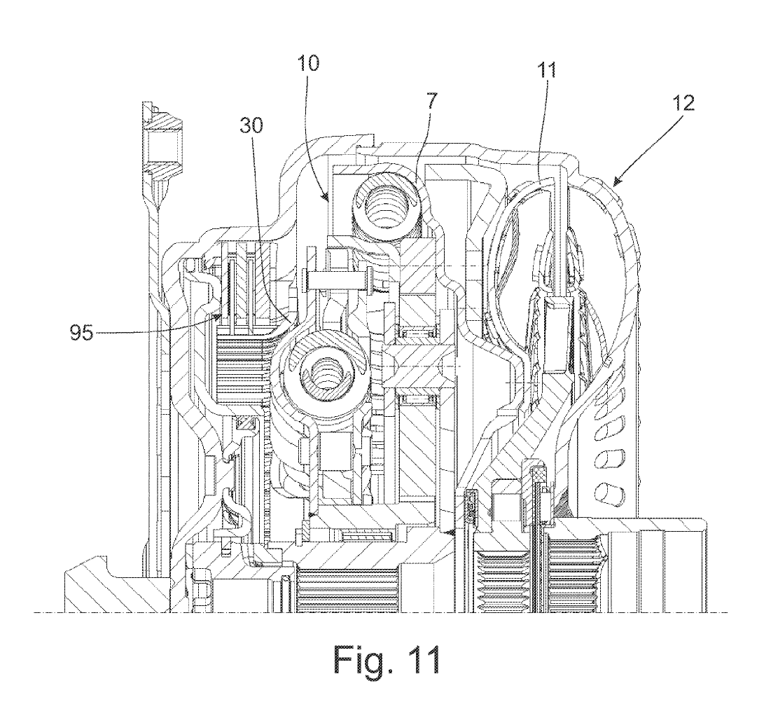

FIG. 11 shows a torsional vibration damping arrangement 10 constructed in combination with a lockup clutch 95 and a torque converter 12.

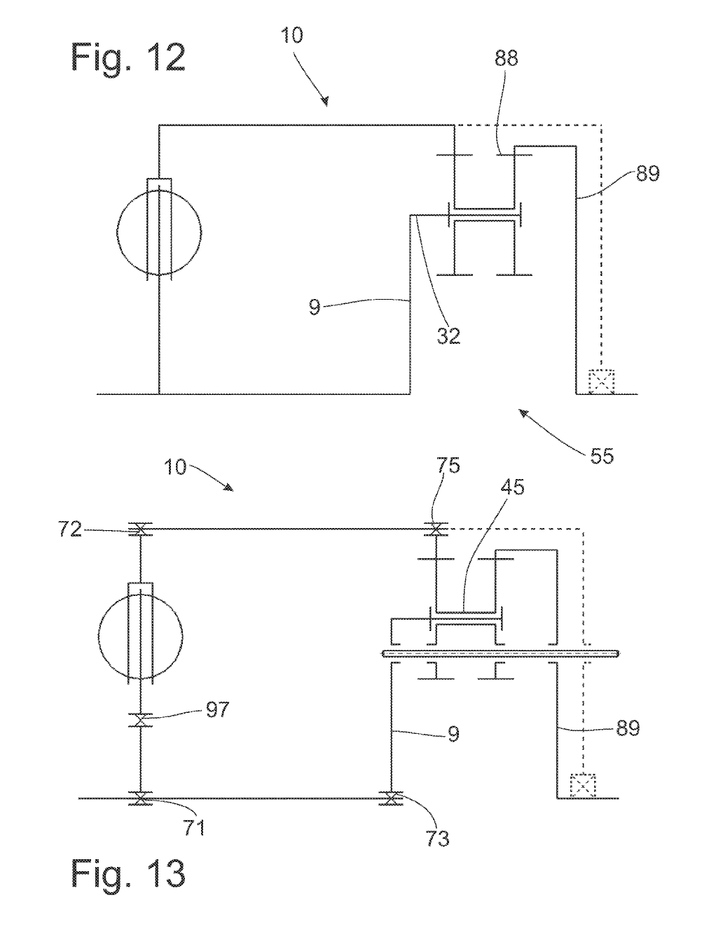

FIG. 12 shows a torsional vibration damping arrangement 10 as already described, but with a planetary gear unit 61 as coupling arrangement 4 in which the output to the output region 55 is formed by an output ring gear 88 with an output ring gear carrier 89 connected to the latter so as to be fixed with respect to rotation relative to it. The second input element 32 of the coupling arrangement 41 is formed in this instance by the planet wheel carrier 9.

FIG. 13 shows a torsional vibration damping arrangement 10 as described in FIG. 12, but with possible disconnection points 71, 72, 73, 74, 97 for assembling and for fixating the planet wheel carrier 9 with respect to the planet wheel element 45 and output ring gear carrier 89.

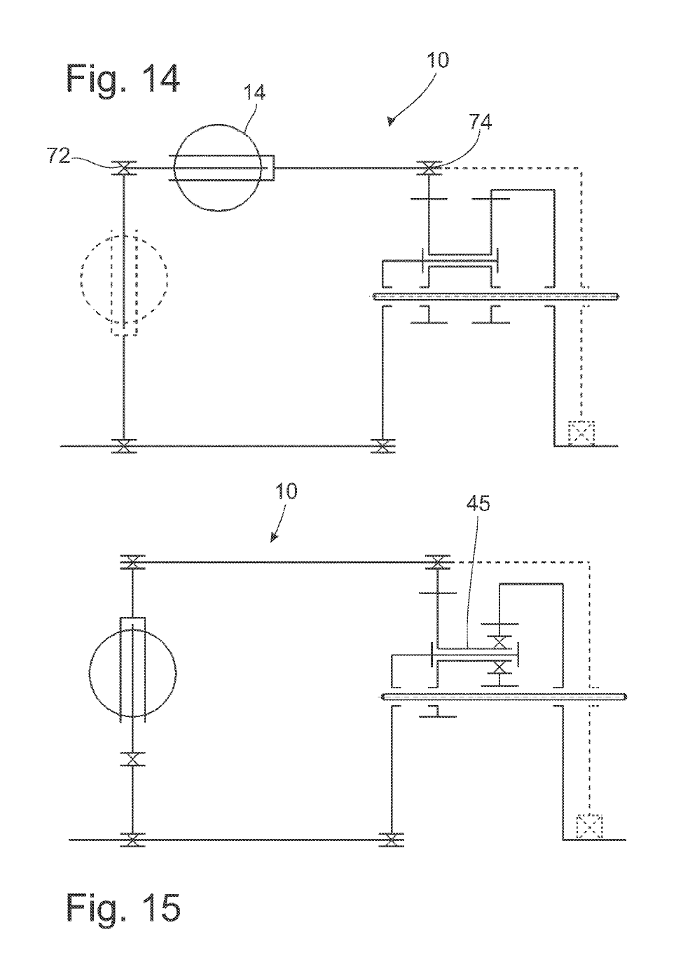

FIG. 14 shows a torsional vibration damping arrangement 10 as in FIG. 13, but with an additional spring arrangement 14 positioned between the two second connection points 72, 74.

FIG. 15 shows a torsional vibration damping arrangement 10 as in FIG. 13, but with a different arrangement for fixating a planet wheel element 45. In the construction shown here, the planet wheel element 45 is formed as a stepped planet wheel element 99.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-15. (canceled)

16. An assembly for a torsional vibration damping arrangement for a powertrain of a motor vehicle, comprising:
an input region configured to be driven in rotation around an axis of rotation comprising:
a primary mass
an output region, comprising:
a secondary mass;
a coupling arrangement constructed as a preassembled coupling arrangement assembly unit that communicates with the output region, comprising:
a planetary gear unit with a first input element;
a second input element; and
an output element; and
a torque transmission path that transmits a total torque (Mges), which torque transmission path extends between the input region and the output region, wherein the torque transmission path from the input region to the coupling arrangement is divided into a first torque transmission path for transmitting a first torque component (Ma1) and a parallel, second torque transmission path for transmitting a second torque component (Ma2), wherein the first torque transmission path, the second torque transmission path and, therefore, the first torque component (Ma1) and the second torque component (Ma2) are guided together again at the coupling arrangement to form an output torque (Maus),
wherein the first torque transmission path comprises:
a phase shifter arrangement having a first stiffness, wherein the first stiffness comprises a spring arrangement and the phase shifter arrangement being constructed as a preassembled phase shifter assembly unit comprising:
at least a first connection point and a second connection point in a vibration system,
wherein an input torsional vibration (EDSw) proceeding from the input region is divided into a first torsional vibration component (DSwA1) and a second torsional vibration component (DSwA2) by being conducted via the first torque transmission path and via the second torque transmission path,
wherein during an operation of the vibration system in a speed range above at least one limit speed at which the vibration system is operated in a resonant range, the first torsional vibration component (DSwA1) and the second torsional vibration component (DSwA2) are superpimosed at the coupling arrangement such that the first torsional vibration component (DSwA1) and the second torsional vibration component (DSwA2) are destructively superpimosed, and an output torsional vibration (ADSw) which is minimized relative to the input torsional vibration (EDSw) is present at the output element of the coupling arrangement,
wherein the preassembled coupling arrangement assembly unit comprises:
at least a first connection point corresponding to the first connection point of the phase shifter assembly unit and a second connection point corresponding to the second connection point of the phase shifter arrangement, and wherein the connection points of the phase shifter assembly unit are axially joined to the connection points of the coupling arrangement assembly unit during an assembly of the phase shifter assembly unit with the coupling arrangement assembly unit.

17. The assembly for a torsional vibration damping arrangement according to claim 16, wherein the coupling arrangement assembly unit comprises:
at least the planetary gear unit with a planet wheel carrier;
a planet wheel pin fastened to the planet wheel carrier; and
a planet wheel element connected to the input region by the first input element and by the second input element, connected to the output region by the output element, and is rotatably supported at the planet wheel pin.

18. The assembly for a torsional vibration damping arrangement according to claim 16, wherein the phase shifter assembly unit comprises at least the vibration system with a primary mass and an intermediate element rotatable with respect to the primary mass around the axis of rotation against an action at least of the spring arrangement.

19. The assembly for a torsional vibration damping arrangement according to claim 16, wherein the first connection point and second connection point of the phase shifter assembly unit and the corresponding first connection point and second connection point of the coupling arrangement assembly unit are displaceable relative to one another in an axial direction along the axis of rotation, and in that at least one of the connection points of the phase shifter assembly unit and at least one of the corresponding connection points of the coupling arrangement assembly unit are configured to engage positively with respect to one another in a circumferential direction around the axis of rotation.

20. The assembly for a torsional vibration damping arrangement according to claim 16, wherein the coupling arrangement assembly unit comprises:
a spring set arranged in series with the spring set of the phase shifter assembly unit after assembly of the coupling arrangement assembly unit with the phase shifter assembly unit.

21. The assembly for a torsional vibration damping arrangement according to claim 16, wherein at least one of the connection points of the phase shifter assembly unit and one of the corresponding connection points of the coupling arrangement assembly unit form an interference fit when axially joined together.

22. The assembly for a torsional vibration damping arrangement according to claim 16, wherein after the axial joining of the phase shifter assembly unit and the coupling arrangement assembly unit at least one of the connection points of the phase shifter assembly unit is connected to the corresponding connection point of the coupling arrangement assembly unit by a bonding connection method.

23. The assembly for a torsional vibration damping arrangement according to claim 22, wherein the bonding connection method is a welding method.

24. The assembly for a torsional vibration damping arrangement according to claim 17, wherein the planet wheel element is secured against twisting with respect to the planet wheel carrier by a fixating element before the phase shifter assembly unit is assembled with the coupling arrangement assembly unit.

25. The assembly for a torsional vibration damping arrangement according to claim 24, wherein:
the planet wheel element comprises a recess;
the planet wheel carrier comprises a corresponding recess,
wherein the fixating element is inserted into both recesses to prevent twisting of the two component parts relative to one another.

26. The assembly for a torsional vibration damping arrangement according to claim 16, wherein an engine-side cover plate of the phase shifter assembly unit is connected via a lockup clutch to a disk carrier so as to be fixed with respect to rotation relative to it.

27. The assembly for a torsional vibration damping arrangement according to claim 16, wherein a transmission-side cover plate is connected to a turbine of a torque converter so as to be fixed with respect to rotation relative to it.

28. The assembly for a torsional vibration damping arrangement according to claim 16, wherein a radially outwardly arranged connection point of the phase shifter assembly unit comprises a hub disk, and a corresponding connection point of the coupling arrangement assembly unit comprises a hub ring.

29. The assembly for a torsional vibration damping arrangement according to claim 28, wherein
the hub disk comprises a spring control segment and a torsion stop, and
the hub ring comprises a spring control segment and a torsion stop.

30. The assembly for a torsional vibration damping arrangement according to claim 29, wherein the spring arrangement is clamped between the spring control segment of the hub disk and the spring control segment of the hub ring after the phase shifter assembly unit has been assembled with the coupling arrangement assembly unit.
